(19) United States
(12) Patent Application Publication
(10) Pub. No.: US 2011/0012864 A1
(43) Pub. Date: Jan. 20, 2011

(54) RESISTIVE TOUCH PANEL AND METHOD FOR DETECTING TOUCH POINT TYPE

(75) Inventor: Hung-Yi Lin, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., TAIPEI (TW)

(21) Appl. No.: 12/837,107

(22) Filed: Jul. 15, 2010

(30) Foreign Application Priority Data
Jul. 20, 2009 (TW) 098124449

(51) Int. Cl. G06F 3/045

(52) U.S. Cl. 345/174

(57) ABSTRACT

A resistive touch panel and a method for detecting the touch point type are disclosed. The resistive touch panel has multiple detecting areas. The method includes the following steps: obtaining the positions of multiple touch points when a touch operation is generated on the touch panel; determining whether the touch points can be combined to be a combined touch point when the touch points are located at adjacent areas; and determining whether the combined touch point is a first-type touch point or a second-type touch point when the touch points can be combined to be the combined touch point.

### FIELD OF THE INVENTION

The invention relates to a resistive touch panel and a detecting method thereof and, more particularly, to a resistive touch panel and the method for detecting a touch point type.

### BACKGROUND OF THE INVENTION

With the fast development of the computer technology, a touch panel is widely used in a mobile phone screen, a computer screen, a personal digital assistant (PDA) screen and so on. Basically, the touch panel may replace a mouse to be a computer input device. In current the touch panels, a resistive touch panel is most popular.

As shown in FIG. 1A, it is a side view showing a conventional resistive touch panel. Multiple strip-shaped indium tin oxide (ITO) layers 102 are formed on the surface of a transparent glass substrate 100. In addition, multiple strip-shaped ITO layers 112 are formed on the surface of a transparent film 110. The strip-shaped ITO layers 102 on the transparent glass substrate 100 are perpendicular to the strip-shaped ITO layers 112 on the transparent film 110. In addition, multiple transparent spacer dots 120 isolate the strip-shaped ITO layers 102 on the transparent glass substrate 100 and the strip-shaped ITO layers 112 on the transparent film 110 to prevent them from contacting.

When the user presses the transparent film 110 with a finger or a stylus, the strip-shaped ITO layer 112 on the transparent file 110 is transformed and contacts the strip-shaped ITO layer 102 on the transparent glass substrate 100. The control circuit (not shown) of the touch panel calculates the position of the touch point.

As shown in FIG. 1B, it is a top view showing the conventional resistive touch panel. For example, four electrodes are disposed around the touch panel 10. They are a negative Y (Y−) electrode, a positive Y (Y+) electrode, a negative X (X−) electrode and a positive X (X+) electrode. In addition, the strip-shaped ITO layers 102 on the glass substrate are arranged vertically, and the two ends of all the strip-shaped ITO layers are connected to the negative Y (Y−) electrode and positive Y (Y+) electrode. The strip-shaped ITO layers 112 on the transparent film 110 are arranged horizontally, and the two ends of all the strip-shaped ITO layers 112 are connected to the negative X (X−) electrode and the positive X (X+) electrode. All the strip-shaped ITO layers 102 and 112 may be equivalent to resistors.

In addition, the control circuit 150 is respectively connected to the negative Y (Y−) electrode, the positive Y (Y+) electrode, the negative X (X−) electrode and the positive X (X+) electrode via the Y− line, the Y+ line, the X− line and the X+ line. When touch points are generated by the user on the touch panel 10, the control circuit 150 may obtain the position of the touch point quickly.

As shown in FIG. 2A, it is a schematic diagram showing that whether touch points are generated on the conventional resistive touch panel is detected. First, to know about whether the user touches the touch panel, the control circuit (not shown) connects a power source (Vcc) to the positive X (X+) electrode, connects the ground end to the negative Y (Y−) electrode, connects the negative X (X−) electrode to the control circuit to provide voltage Va and open the positive Y (Y+) electrode.

Obviously, when the user does not press the touch panel, the upper strip-shaped ITO layers and the lower strip-shaped ITO layers do not contact each other. Therefore, the control circuit may receive the voltage Va at the negative X (X−) electrode which is equal to the voltage Vcc. It represents that the user does not press the touch panel.

When the user presses the touch panel using a stylus 140, the upper strip-shaped ITO layers contact the lower strip-shaped ITO layers at the touch point A. Therefore, the control circuit detects that the negative X (X−) electrode receives a voltage

$$Va = ( \frac{( R 4 + Rz ) \cdot Vcc}{R 1 + Rz + R 4} )$$

which is smaller than the voltage Vcc. That is, it is determined that the user presses the touch panel, and that is, the control circuit determines that a touch operation is generated. The Rz is the contact resistance when the two strip-shaped ITO layers contact each other.

As shown in FIG. 2B, it is a schematic diagram showing the process of calculating the horizontal position of the touch point on the conventional resistive touch panel. The control circuit calculates the position of the touch point after it determines that the user generates the touch operation. To obtain the horizontal position of the touch point, when the control circuit detects the existence of the touch point A, it performs a switching process to connect a power source (Vcc) to the positive X (X+) electrode, connect the ground end to the negative X (X−) electrode, connect the positive Y (Y+) electrode to the control circuit to receive the voltage Vx and open the negative Y (Y−) electrode.

Obviously, the voltage on the positive Y (Y+) electrode is

$$Vx = \frac{R 2 \cdot Vcc}{R 1 + R 2} .$$

As shown in FIG. 2B, when the touch point A gets closer to the right side, the voltage Vx is higher, and on the contrary, when the touch point A gets closer to the left side, the voltage Vx is lower. Therefore, the control circuit may convert the voltage Vx via an analog to digital conversion to obtain the horizontal position of the touch point.

As shown in FIG. 2C, it is a schematic diagram showing the process of calculating the touch point on the conventional resistive touch panel. To obtain the vertical position of the touch point A, when the control circuit calculates the horizontal position of the touch point A, it performs the switching process again to connect a power source (Vcc) to the positive Y (Y+) electrode, connect the ground end to the negative Y (Y−) electrode, connect the positive X (X+) electrode to the control circuit to receive the voltage Vy and open the negative X (X−) electrode.

The voltage at the positive X (X+) electrode is

$$Vy = \frac{R 4 \cdot Vcc}{R 3 + R 4} .$$

As shown in FIG. 2C, when the touch point A gets closer to the upper side, the voltage Vy is higher, and on the contrary, when the touch point A gets closer to the lower side, the voltage Vy is lower. Therefore, the control circuit may convert the voltage Vy via an analog to digital conversion to obtain the vertical position of the touch point.

The touch panel is a detecting area surrounded by four electrodes (the negative Y electrode, the positive Y electrode, the negative X electrode and the positive X electrode). In addition, FIG. 2A shows the detection of whether the touch operation is generated on the detecting area. When the touch operation is generated, the control circuit performs the steps in FIG. 2B and FIG. 2C to obtain the horizontal position and vertical position of the touch point. On the contrary, when the touch point is not generated, the control circuit stays in the state of FIG. 2A and continues waiting for the generation of the touch operation.

Since the conventional resistive touch panel is an analog touch panel, when multiple touch points are generated by a user in the touch panel simultaneously, the control circuit is unable to detect multiple touch points, and it may calculate a wrong touch point. For example, as shown in FIG. 3, it is a schematic diagram showing that multiple touch points are generated on the conventional resistive touch panel. The detecting area 160 is defined by four electrodes (not shown). When two touch points A1 and A2 are generated simultaneously in the detecting area 160, supposing that the horizontal position and vertical position of the touch point A1 is (x1, y1), and the horizontal position and vertical position of the touch point A2 is (x2, y2), the control circuit may wrongly detect a third touch point A3. The horizontal position and vertical position of A3 may be detected to be

$$( \frac{x 1 + x 2}{2} , \frac{y 1 + y 2}{2} )$$

To detect multiple touch points on the resistive touch panel, the new type of resistive touch panel is developed. As shown in FIG. 4A, it is a schematic diagram showing the resistive touch panel which may detect multiple touch points. In FIG. 4A, the resistive touch panel includes four groups of electrodes (X1+ to X3+, X1 to X3−, Y1+ to Y4+, Y1− to Y4−). In addition, in the resistive touch panel, the X+ group and X− group have three electrodes, respectively, and the Y+ group and Y− group have four electrodes, respectively. The amount of electrodes in each group is not limited herein, and it may be changed.

In FIG. 4A, three electrodes in a positive X (X+) group are a positive X1 (X1+) electrode, a positive X2 (X2+) electrode and a positive X3 (X3+) electrode; three electrodes in a negative X (X−) group are a negative X1 (X1−) electrode, a negative X2 (X2−) electrode and a negative X3 (X3−) electrode; three electrodes in a positive Y (Y+) group are a positive Y1 (Y1+) electrode, a positive Y2 (Y2+) electrode, a positive Y3 (Y3+) electrode and a positive Y4 (Y4+) electrode; and three electrodes in a negative Y (Y−) group are a negative Y1 (Y1−) electrode, a negative Y2 (Y2−) electrode, a negative Y3 (Y3−) electrode and a negative Y4 (Y4−) electrode. Obviously, four groups of electrodes generate twelve areas. For example, the X1+electrode, the X1− electrode, the Y1+ electrode and the Y1− electrode form the detecting area D11, and others are obtained by parity of reasoning.

In addition, the multiplex switching circuit 230 are connected to all electrodes, and it may selectively connect an X+ line to part or all electrodes in the X+ group, connect an X− line to part or all electrodes in the X− group, connect a Y+ line to part or all electrodes in the Y+ group and connect a Y− line to part or all electrodes in the Y-group according to a control signal of the control circuit 250.

The touch panel which may detect multiple touch points in the embodiment of the invention is illustrated hereinbelow in detail. As shown in FIG. 4B, it is a schematic diagram showing an equivalent circuit during the touch point detecting procedure. To detect whether a touch operation is generated on the touch panel 200, the control circuit 250 connects the X+ line to all electrodes in the X+ group, connects the X− line to all electrodes in the X− group, connects the Y+ line to all electrodes in the Y+ group and connects the Y− line to all electrodes in the Y− group. In addition, the control circuit 250 performs the first switching action to connect a power source (Vcc) to the X+ line, connect the ground end to the Y− line, take a signal of the X− line as a determining signal and open the Y+ line. The control circuit 250 may detect whether a touch operation is generated in all areas of the touch panel 200, and the detecting way is the same as that in FIG. 2A, and it is not illustrated herein.

For example, when the control circuit 250 knows that the touch operation is generated by the user (for example, the touch point B1 is generated), the control signal of the control circuit 250 controls the multiplex switching circuit 230 to orderly connect the X− line, the X+ line the Y− line and the Y+ line to the twelve detecting areas and detects whether the touch point is generated in the twelve detecting areas. At last, as shown in FIG. 4C, the touch point B1 is obtained at the area D31 defined by the Y1+, Y1−, X3+ and X3− electrodes, and the horizontal position and vertical position of the touch point B1 is obtained. In addition, the way of calculating the position of the touch point B1 is the same as those in FIG. 2B and FIG. 2C, and it is not illustrated again.

Similarly, as shown in FIG. 5, when multiple touch points (such as B1, B2 and B3) are generated at a time by the user, the control circuit 250 knows that the user generates the touch operation. However, the control circuit 250 cannot know whether the user generates a single touch point or multiple touch points at the moment.

Then, the control signal of the control circuit 250 controls the multiplex switching circuit 230 to connect the X− line, the X+ line, the Y-line, and the Y+ line to the twelve detecting areas and detects whether the touch point is generated in the twelve detecting areas. At last, it is known that the detecting area D₁₃, the detecting area D₃₁, the detecting area D₃₃ have a touch point, respectively, and the control circuit may calculate the position of the touch point B2 in the detecting area D₁₃, the position of the touch point B1 in the detecting area D₃₁ and the position of the touch point B3 in the detecting area D₃₄.

Sometimes, the user may carelessly generate a plurality of touch points, and the control circuit of the conventional touch panel which may detect multiple touch points also calculates the positions of the touch points. As shown in FIG. 6, when the user operates the touch panel with the stylus 140, he or she always puts the finger 130 or the palm 135 on the touch panel 200. At that moment, the control circuit calculates multiple touch points. However, the touch point generated by the finger or the palm is not the effective touch point.

### SUMMARY OF THE INVENTION

A resistive touch panel and a method for detecting the touch point type are disclosed. The resistive touch panel has multiple detecting areas. The method includes the following steps: obtaining the positions of multiple touch points when a touch operation is generated on the touch panel; determining whether the touch points can be combined to be a combined touch point when the touch points are located at adjacent detecting areas; and determining whether the combined touch point is the first-type touch point or the second-type touch point.

The invention further discloses a resistive touch panel which includes: a first-direction first electrode group including m electrodes; a first-direction second electrode group including m electrodes; a second-direction first electrode group including n electrodes; and a second-direction second electrode group including n electrodes; a multiplex switching circuit and a control circuit. The multiplex switching circuit is connected to all the 2m+2n electrodes, and the control circuit is connected to the multiplex switching circuit and determines whether the touch points can be combined to be a combined touch point when the touch operation is generated, and further determines whether the combined touch point is the first-type touch point or the second-type touch point when the touch points can be combined to be a combined touch point.

These and other features, aspects and advantages of the present invention will become better understood with regard to the following description, appended claims, and accompanying drawings.

### BRIEF DESCRIPTION OF THE DRAWINGS

FIG. 1A is a side view diagram showing a conventional resistive touch panel;

FIG. 1B is a top view diagram showing the conventional resistive touch panel;

FIG. 2A is a schematic diagram showing detecting whether touch points are generated on the conventional resistive touch panel;

FIG. 2B is a schematic diagram showing calculating the horizontal position of the touch point on the conventional resistive touch panel;

FIG. 2C is a schematic diagram showing calculating the touch point on the conventional resistive touch panel;

FIG. 3 is a schematic diagram showing that multiple touch points are generated on the conventional resistive touch panel;

FIG. 4A is a schematic diagram showing the resistive touch panel which may detect multiple touch points;

FIGS. 4B and 4C are schematic diagrams showing an equivalent circuit during the touch point detecting procedure;

FIG. 5 is a schematic diagram showing that multiple touch points are detected on the resistive touch panel;

FIG. 6 is a schematic diagram showing that the user operates the touch panel;

FIG. 7A is a schematic diagram showing that the touch point is generated by a finger;

FIG. 7B, it is a schematic diagram showing that the touch point is generated by a stylus;

FIG. 8 is a schematic diagram showing the resistive touch panel which may detect multiple touch points;

FIG. 9 is a flow chart showing the method for distinguishing the positions of the touch points;

FIG. 10A to FIG. 10D are schematic diagrams showing different touch points;

FIG. 11A is a flow chart showing the method for determining the touch point type in the first embodiment of the invention; and

FIG. 11B is a flow chart showing the method for determining the touch point type in the second embodiment of the invention.

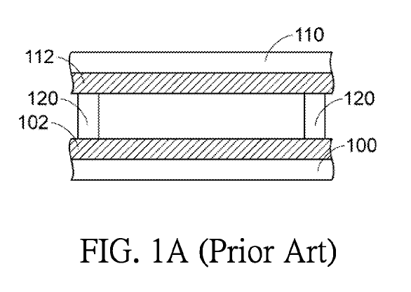

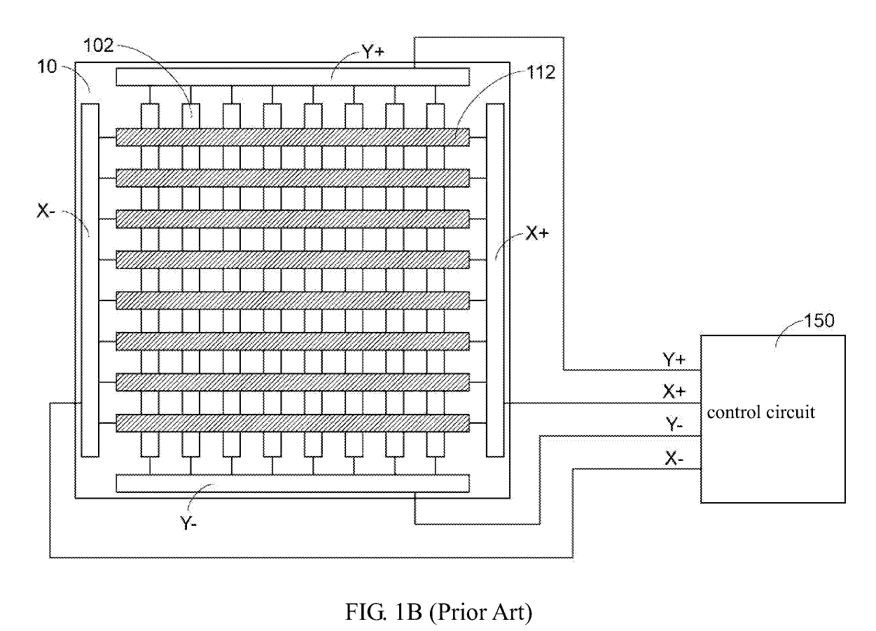

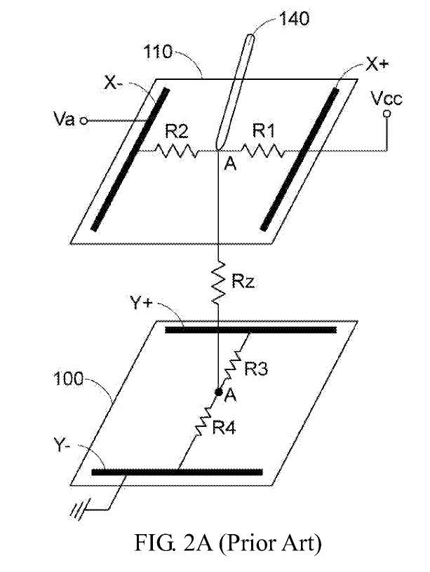

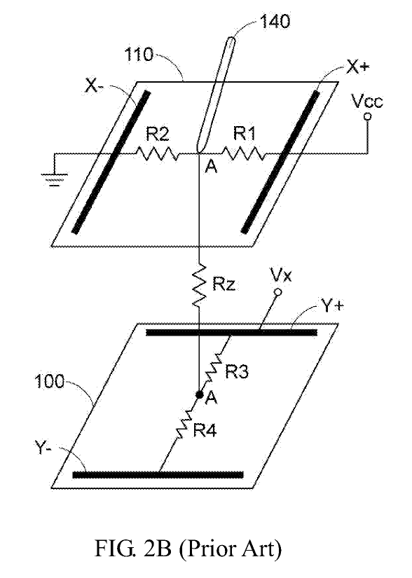

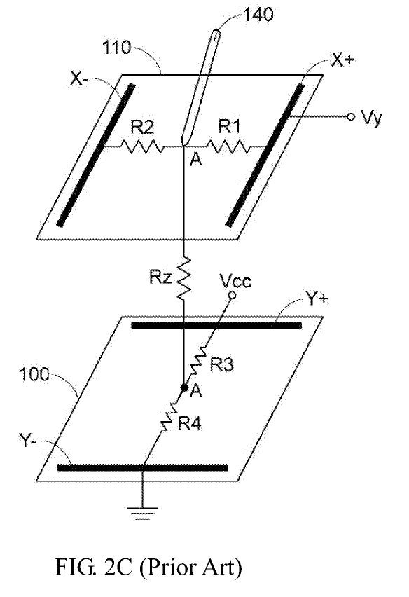

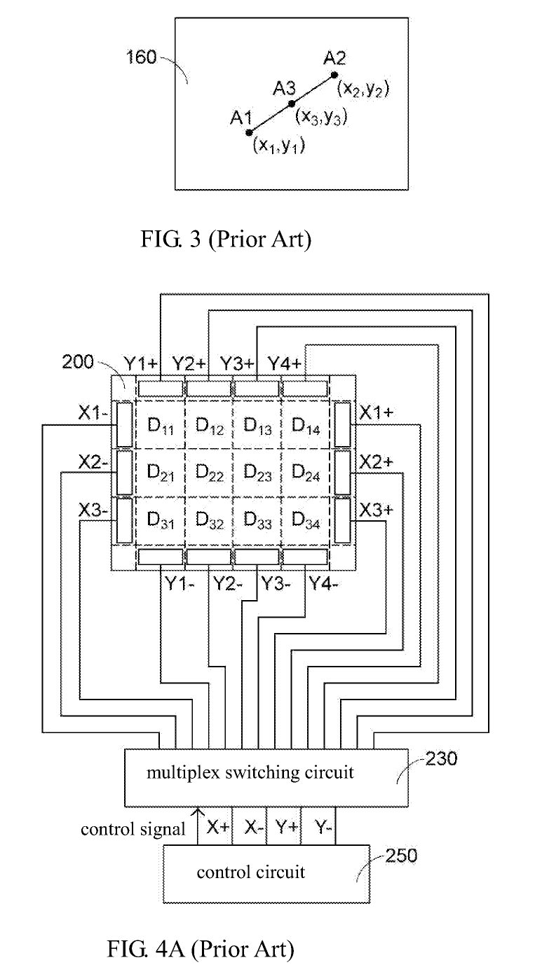

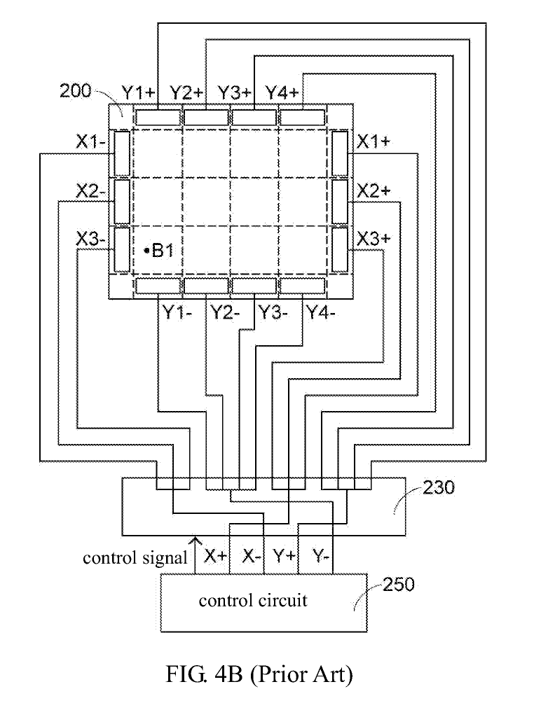

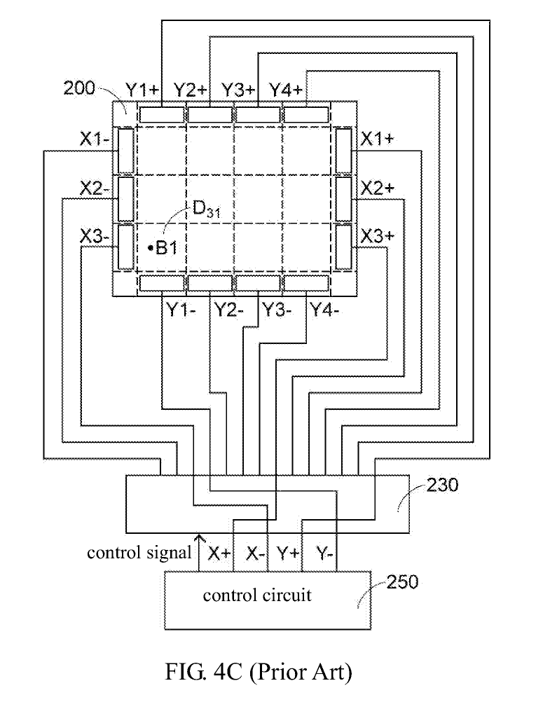

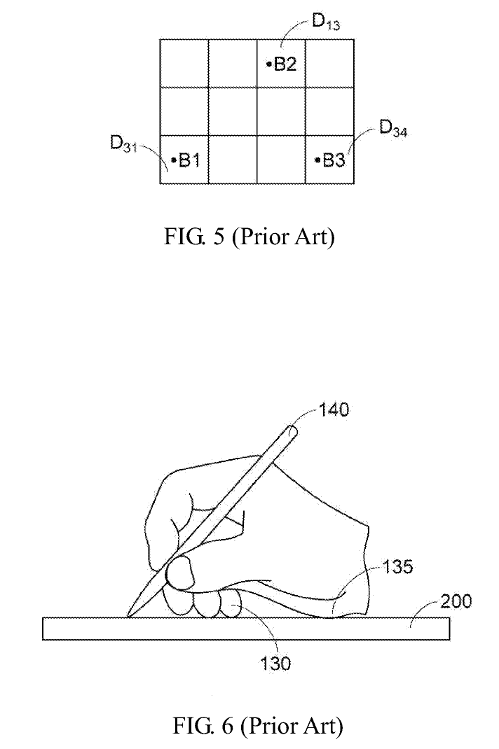

### DETAILED DESCRIPTION OF THE PREFERRED EMBODIMENT

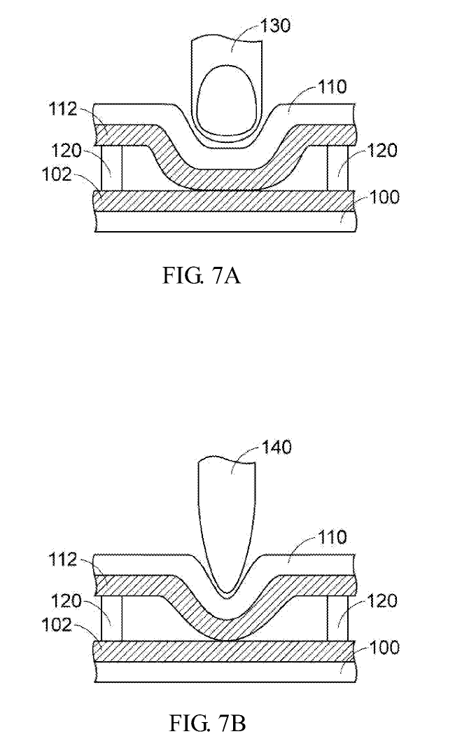

FIG. 7A is a schematic diagram showing that the touch point is generated by a finger. When a finger 130 is used to press the touch panel, the contact area between the upper and lower stripe-shaped ITO layers 112 and 102 is larger due to the large contact area. Similarly, when the touch point is generated by a palm, the contact area between the upper and lower stripe-shaped ITO layers 112 and 122 is also larger. In addition, as shown in FIG. 7B, it is a schematic diagram showing that the touch point is generated by a stylus 140. Since the area of the penpoint of the stylus is small, when the stylus is used to press the touch panel, the contact area between the upper and lower ITO layers is small. In the invention, the contact area is used to determine whether the touch point is the first-type touch point or the second-type touch point. The first-type touch point is the small-area touch point, such as the stylus touch point, the sharp object touch point, and the palm touch point, and the second-type touch point is a large-area touch point such as a finger touch point and a palm touch point.

Generally, to detect multiple touch points accurately, the conventional resistive touch panel which may detect multiple touch points should have multiple detecting areas. In other words, the electrodes in the X+ group, X− group, Y+ group and Y− group are too short, and thus the amount of the detecting areas is larger, and the area of each detecting area is smaller.

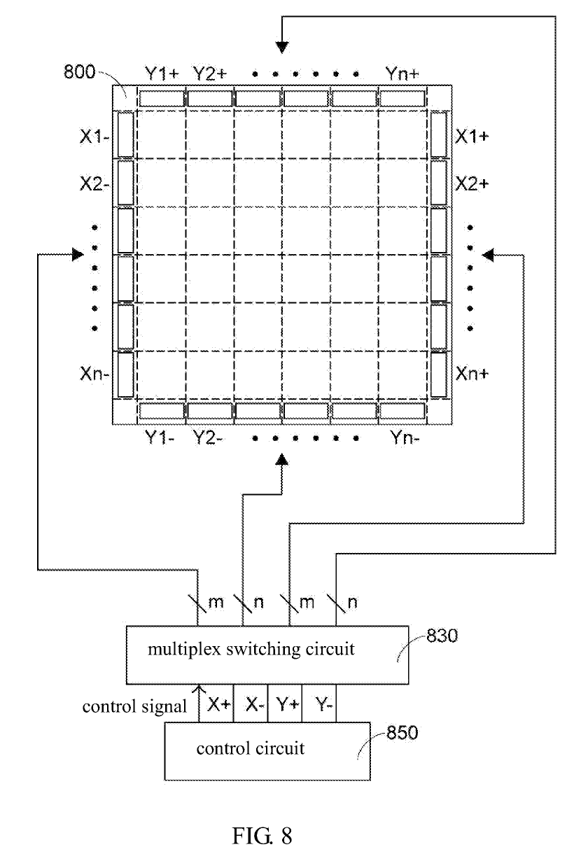

FIG. 8 is a schematic diagram showing the resistive touch panel which may detect multiple touch points. The resistive touch panel in FIG. 8 includes four electrode groups, which are an X-direction first electrode group (X1+ to Xm+), an X-direction second electrode group (X1− to Xm−), a Y-direction first electrode group (Y1+ to Yn+) and a Y-direction second electrode group (Y1− to Yn−). The resistive touch panel 800 herein is divided into m×n detecting areas.

The multiplex switching circuit 830 is connected to all electrodes, and it may selectively connect an X+ line to part or all electrodes in the X+ group, connect an X− line to part or all electrodes in the X− group, connect a Y+ line to part or all electrodes in the Y+ group, and connect a Y− line to part or all electrodes in the Y− group.

When the detecting areas are small, if the user touches the touch panel with his or her finger or palm, he or she may easily touch the edge of the detecting area and make the adjacent detecting areas generate multiple touch points at the same time. That is, when multiple touch points are not generated at the adjacent detecting areas, multiple touch points can be outputted directly. On the contrary, when multiple touch points are generated on adjacent detecting areas, they must be further determined.

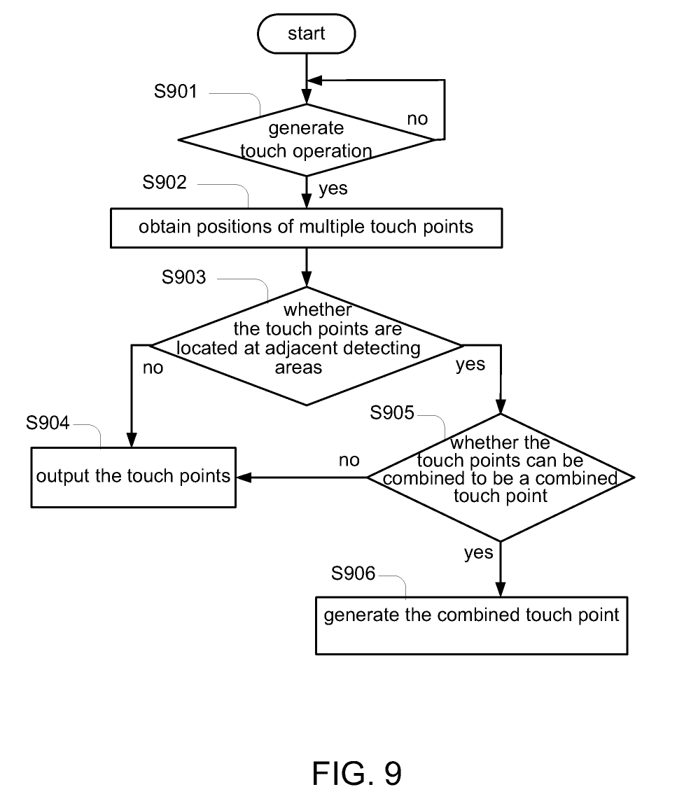

FIG. 9 is a flow chart showing the method for distinguishing the positions of the touch points. The control circuit continuously detects the touch operation before it detects the touch operation. When the control circuit detects the touch operation, it calculates the positions of the touch points and obtains multiple positions of the touch points (step S902).

Then, whether the touch points are located at adjacent detecting areas are determined (step S903). When the case in step S903 is “no”, the positions of the touch points are outputted directly (step S904), and on the contrary, when the case in step S903 is “yes”, whether the touch points can be combined to be a combined touch point is further determined (S905).

When the touch points cannot be combined, the positions of the touch points are directly outputted (S904). When it is determined that the touch points can be combined, a combined touch point is outputted.

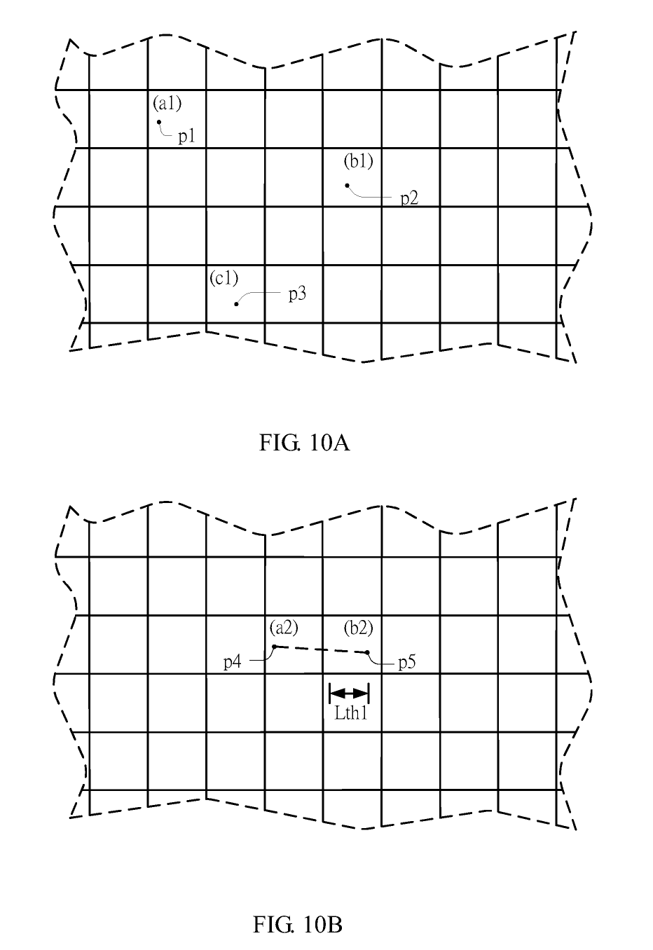

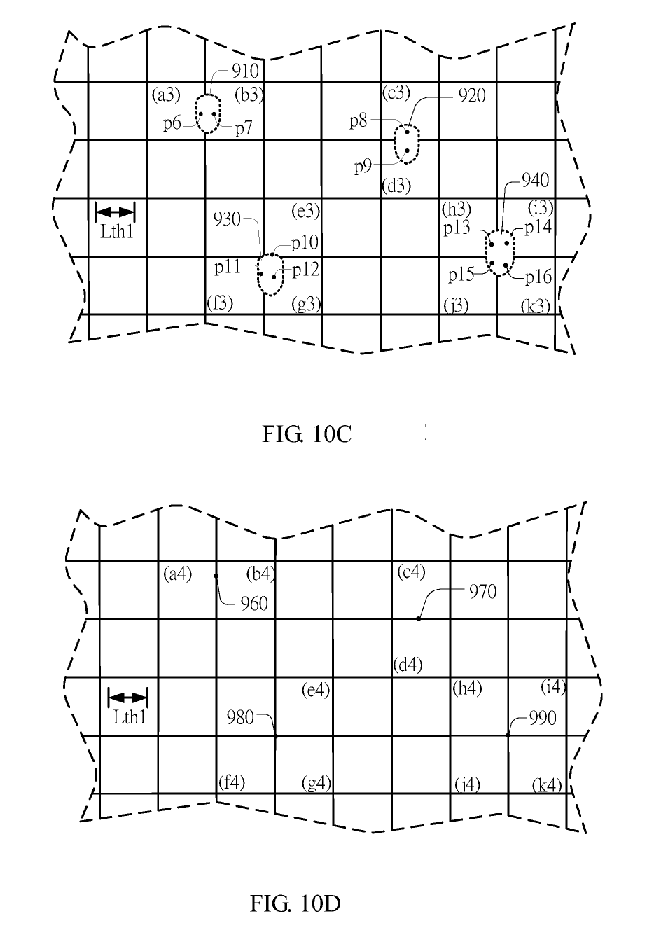

The touch points of the examples in FIG. 10A to FIG. 10D are used to illustrate the flow chart in FIG. 9. The touch points in FIGS. 10A and 10B cannot be combined to be a combined touch point, and the touch points in FIG. 10C and FIG. 10D can be combined to be a combined touch point.

As shown in FIG. 10A, when the touch operation is generated (step S901), the control circuit 850 detects the position of the touch point p1 in the detecting area (a1), the position of the touch point p2 in the detecting area (b1) and the position of the touch point p3 in the detecting area (c1) (S902). Since the detecting areas (a1), (b1) and (c1) are not adjacent to each other, the control circuit 850 directly outputs the position of the touch point p1, the position of the touch point p2 and the position of the touch point p3 (step S904).

As shown in FIG. 10B, when the touch operation is generated (step S901), the control circuit 850 calculates the position of the touch point p4 in the detecting area (a2) and the position of the touch point p5 in the detecting area (b2). Since the detecting areas (a2) and (b2) are adjacent detecting areas, the control circuit 850 goes on to determine whether the touch points p4 and p5 can be combined (step S904).

During the step of determining whether the touch points can be combined (step S904), a first threshold length (Lth1) may be preset in the control circuit, and the first threshold length (Lth1) is compared with the distance between the touch points p4 and p5. When the distance between p4 and p5 is longer than the first threshold length (Lth1), the touch points p4 and p5 cannot be combined, and the positions of the touch points p4 and p5 are outputted (step S904).

Taking the finger touch point 910 in FIG. 10C as an example, when the touch operation is generated (step S901), the control circuit 850 calculates the position of the touch point p6 in the detecting area (a3) and the position of the touch point p7 in the detecting area (b3). Since the detecting areas (a3) and (b3) are adjacent detecting areas (step S903), the control circuit 850 goes on to determine whether touch points p6 and p7 can be combined (step S904).

During the step of determining whether the touch points can be combined (step S904), a first threshold length (Lth1) may be preset in the control circuit, and the first threshold length (Lth1) is compared with the distance between the touch points p6 and p7. The finger touch point 910 generates two touch points p6 and p7 in the detecting areas (a3) and (b3), respectively, and the distance between the touch points p6 and p7 is shorter than the first threshold length (Lth1). Therefore, the touch points p6 and p7 can be combined to be a combined touch point (step S906). That is, supposing that the position of p6 is (x6, y6) and the position of p7 is (x7, y7), the position of the combined touch point is

$$( \frac{x 6 + x 7}{2} , \frac{y 6 + y 7}{2} ) .$$

The finger touch point 920 in FIG. 10C generates the touch points p8 and p9 in adjacent detecting areas (c3) and (d3). The distance between p8 and p9 is shorter than the first threshold length (Lth1), and therefore the touch points p8 and p9 can be combined to be a combined touch point (step S906). That is, supposing that the position of p8 is (x8, y8) and the position of p9 is (x9, y9), the position of combined touch point is

$$( \frac{x 8 + x 9}{2} , \frac{y 8 + y 9}{2} ) .$$

The finger touch point 930 in FIG. 10C generates three touch points p11, p12 and p13 in the adjacent detecting areas (e3), (f3) and (g3). The distance between any two touch points is shorter than the first threshold length (Lth1). Therefore, the touch points p10, p11 and p12 can be combined and a combined touch point can be outputted (S906). That is, supposing that the position of the touch point p10 is (x10, y10), the position of the touch point p11 is (x11, y11) and the position of the touch point p11 is (x12, y12), the position of the combined touch point is

$$( \frac{x 10 + x 11 + x 12}{3} , \frac{y 10 + y 11 + y 12}{3} ) .$$

The finger touch point 940 in FIG. 10C generates the touch points p13, p14, p15 and p16 in adjacent detecting areas (h3), (i3), (j3) and (k3). The distance between any two adjacent touch points is shorter than the first threshold length (Lth1), and the touch points p13, p14, p15 and p16 can be combined to be a combined touch point and outputted (step S906). That is, supposing that the position of p13 is (x13, y13), the position of p14 is (x14, y14), the position of p15 is (x15, y15) and position of p16 is (x16, y16), the position of combined touch point is

$$( \frac{x 13 + x 14 + x 15 + x 16}{4} , \frac{y 13 + y 14 + y 15 + y 16}{4} ) .$$

Similarly, when a stylus touch point touches the edge of the detecting areas of the touch panel to make adjacent detecting areas have touch points at the same time, the stylus touch point 960 in FIG. 10D generates two touch points in two adjacent detecting areas (a4) and (b4). The two touch points are very close to each other. The distance between the two touch points generated by the stylus is shorter than the first threshold length (Lth1), and therefore the two touch points can be combined to be a combined touch point, and the combined touch point is outputted (S906).

The stylus touch point 970 in FIG. 10D generates two touch points in the adjacent detecting areas (c4) and (d4), and the touch points are very close to each other. The distance between the two touch points generated by the stylus is shorter than the first threshold length (Lth1), and therefore the two touch points can be combined to be a combined touch point (S906).

The stylus touch point 980 in FIG. 10D generates three touch points in the adjacent detecting areas (e4), (f4) and (g4), and the three touch points are very close to each other. The distance between any two touch points generated by the stylus touch point 980 is shorter than the first threshold length (Lth1), and the three touch points can be combined to be a combined touch point and outputted (S906).

When the stylus touch point 990 generates four touch points in the adjacent detecting areas (h4), (i4) (j4) and (k4), the four touch points are very close to each other. The distance between any two touch points generated by the stylus touch point 990 is shorter than the first threshold length (Lth1), and the four touch points can be combined to be a combined touch point and outputted (S906).

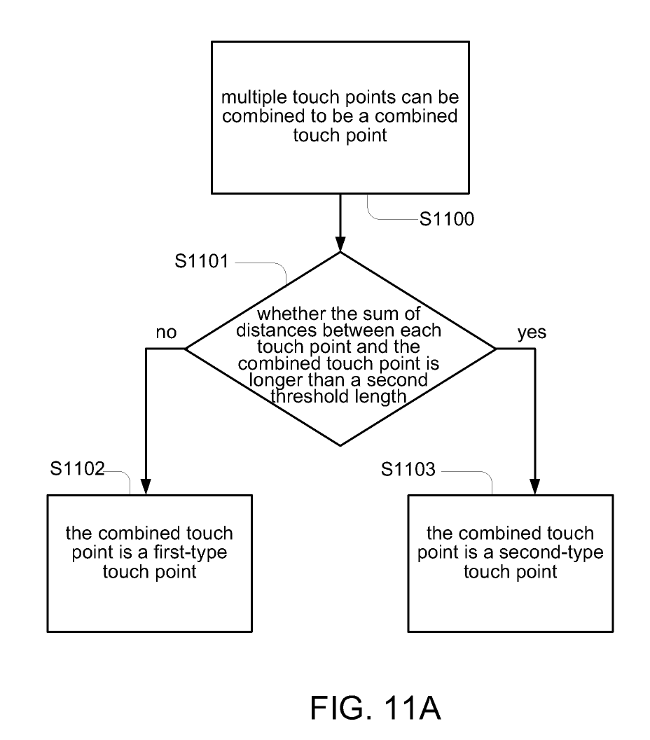

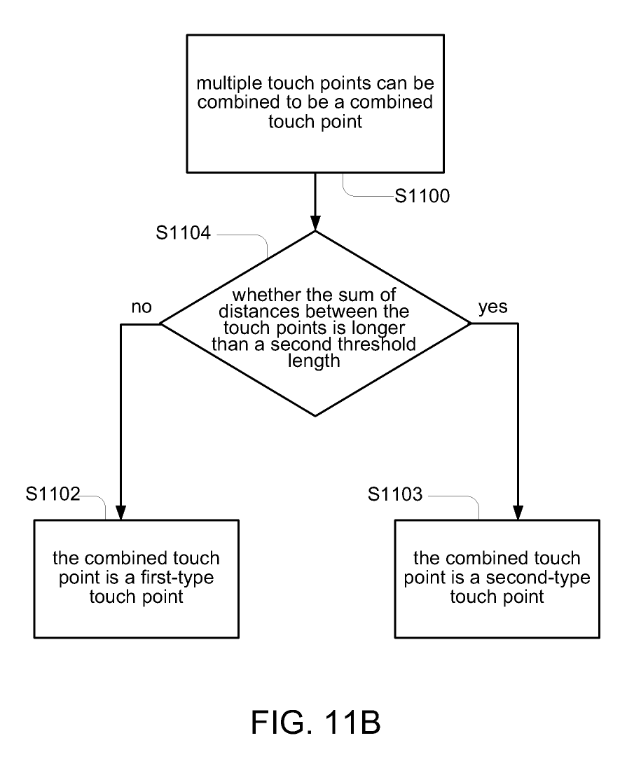

When the combined touch point is generated, the control circuit 850 may further determine the type of the combined touch point. FIG. 11A is a first embodiment showing the method for determining the touch point type. When it is determined that multiple touch points can be combined to be a combined touch point (step 1100), the sum of distance between each touch point and the combined touch point is compared with the second threshold length (Lth2).

When the sum of distance between each touch point and the combined touch point is shorter than a second threshold length, it is determined that the combined touch point is a first-type touch point (step 1102); and when the sum of distances between each touch point and the combined touch point is longer than a second threshold length, it is determined that the combined touch point is a second-type touch point (step 1103).

Therefore, in the invention, multiple touch points are obtained after the touch operation is generated. When multiple touch points are detected at each of the detecting areas at the edge, whether the touch points can be combined to be a combined touch point is determined according to the amount of the touch points and the distance between the touch points, and the type of the combined touch point is further determined.

In addition, step S1101 can also be achieved by other determining modes. As shown in FIG. 11B, it is a flow chart showing the method for determining the touch point type in the second embodiment of the invention. In step S1104, the sum of distances between any two touch points is compared with the second threshold length (Lth2). When the sum of distances is shorter than the second threshold length (Lth2), it is determined that the combined touch point is the first-type touch point (step 1102), and on the contrary, when the sum of distances is longer than the second threshold length (Lth2), it is determined that the combined touch point is the second-type touch point (step 1103).

As shown in FIG. 10C and FIG. 10D, when the finger touches the edge of the adjacent detecting areas, the distance between the touch points is usually long. On the contrary, when a stylus touches the edge of the adjacent detecting areas, the distance between touch points is usually short. Therefore, a second threshold length (Lth2) may be preset to determine the touch point type when the touch points can be combined to be one combined touch point.

According to the first and second embodiments of the invention, the invention provides a resistive touch panel and the method for determining the touch type. When touch points are generated on adjacent detecting areas, the invention may quickly determine whether the touch points can be combined to be a combined touch point. When the touch points are determined to be combined to be one combined touch point, whether the combined touch point is the first-type touch point or the second-type touch point is further determined.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A method for detecting a touch point type in a resistive touch panel, wherein the resistive touch panel has multiple detecting areas, the method comprising the steps of:
obtaining multiple touch points when a touch operation is generated on a touch panel;
determining whether the touch points are capable of being combined to be a combined touch point when the touch points are located in adjacent detecting areas; and
determining whether the combined touch point is a first-type touch point or a second-type touch point when the touch points are capable of being combined to be a combined touch point.

2. The method for detecting the touch point type according to claim 1, further comprising:
outputting the touch points when the touch points are not located at the adjacent areas.

3. The method for detecting the touch point type according to claim 1, further comprising:
outputting the touch points when the touch points are incapable of being combined to be the combined touch point.

4. The method for detecting the touch point type according to claim 1, wherein the step of determining whether the touch points are capable of being combined to be a combined touch point further comprises:
determining that the touch points are capable of being combined to be the combined touch point when the distance between any two touch points is shorter than a first threshold length.

5. The method for detecting the touch point type according to claim 1, wherein the step of determining whether the combined touch point is a first-type touch point or a second-type touch point when the touch points are capable of being combined to be a combined touch point further comprises:
obtaining the position of the combined touch point;
calculating the sum of distances between each of the touch points and the combined touch point;
determining that the combined touch point is the first-type touch point when the sum of distances is shorter than a second threshold length; and
determining that the combined touch point is the second-type touch point when the sum of distances is longer than the second threshold length.

6. The method for detecting the touch point type according to claim 1, wherein the step of determining whether the combined touch point is a first-type touch point or a second-type touch point when the touch points are capable of being combined to be a combined touch point further comprises:
calculating the sum of distances between any two touch points;
determining that the combined touch point is the first-type touch point when the sum of distances is shorter than a second threshold length; and
determining that the combined touch point is the second-type touch point when the sum of distances is longer than the second threshold length.

7. The method for detecting the touch point type according to claim 1, wherein the first-type touch point is a small-area touch point, and the second-type touch point is a large-area touch point.

8. The method for detecting the touch point type according to claim 1, wherein the first-type touch point is a stylus touch point, a penpoint touch point or a sharp-object touch point, and the second-type touch point is a finger touch point or a palm touch point.

9. A resistive touch panel comprising:
a first-direction first electrode group including m electrodes;
a first-direction second electrode group including m electrodes;
a second-direction first electrode group including n electrodes;
a second-direction second electrode group including n electrodes;
wherein the 2m+2n electrodes divide the resistive touch panel into m×n detecting areas;
a multiplex switching circuit connected to each of the 2m+2n electrodes; and
a control circuit connected to the multiplex switching circuit, wherein the control circuit determines whether the touch points are capable of being combined to be a combined touch point when a touch operation is generated, and determines whether the combined touch point is a first-type touch point or a second-type touch point when the touch points are determined to be capable of being combined to be a combined touch point.

10. The resistive touch panel according to claim 9, wherein the first-type touch point is a small-area touch point, and the second-type touch point is a large-area touch point.

11. The resistive touch panel according to claim 9, wherein the first-type touch point is a stylus touch point, a penpoint touch point or a sharp object touch point, and the second-type touch point is a finger touch point or a palm touch point.
